(19) United States
(12) Patent Application Publication
(10) Pub. No.: US 2003/0179902 A1
(43) Pub. Date: Sep. 25, 2003

(54) Authentication and anti-counterfeit tracking system

(76) Inventors: F. Carl Ambrogio, Greenwich, CT (US); John Alan Jones, Old Greenwich, CT (US)

Correspondence Address: PERMAN & GREEN, 425 POST ROAD, FAIRFIELD, CT, 06824, US

(21) Appl. No.: 10/336,883

(22) Filed: Jan. 6, 2003

Related U.S. Application Data
(60) Provisional application No. 60/345,858, filed on Jan. 4, 2002.
(60) Provisional application No. 60/362,807, filed on Mar. 8, 2002.

(51) Int. Cl. G06K 9/00; G06K 9/36

(52) U.S. Cl. 382/100; 382/232

(57) ABSTRACT

A method for authenticating an association of an object with an entity. The method comprises the steps of providing entity data associated with the entity, generating a unique identification code, combining the unique identification code with a watermark, and connecting the watermark to the object. The entity data associated with the entity is provided for associating the entity with the object. The unique identification code is generated for association with the entity data in an object tracking system. The watermark with which the unique identification code is combined is a non-removable, substantially invisible watermark. The watermark is connected to the object wherein the watermark indicates the association between the object and the entity, and allows tracking, tracing and authentication of the object with the tracking system.

### CROSS-REFERENCE TO RELATED APPLICATION(S)

This application claims the benefit of U.S. Provisional Application No. 60/345,858, filed Jan. 4, 2002, and U.S. Provisional Application No. 60/362,807, filed Mar. 8, 2002, which are incorporated by reference herein in their entirety.

### BACKGROUND OF THE INVENTION

b 1. Field of the Invention

The present invention relates to an anti-counterfeiting system and, more particularly, to an authentication and anti-counterfeiting system that tracks, traces and authenticates an object.

2. Brief Description of Related Developments

There has always been a desire in the interrelations between persons to establish whether objects or items being presented as representative of an event, entity or thing are indeed the “genuine” article or a “fake”. Also, there is a desire to determine whether the person or entity holding themselves out as having the authority to present or hold these representative objects or items, are indeed so authorized. For instance, buyers of manufactured products, or other objects having some desirable characteristic want to assure themselves that the products or objects they are buying are exactly what they are purported to be. The manufacturers of the products wish to protect their property rights in the desirable characteristics of the products and thus also have a desire in ensuring that the buyer purchases the “genuine” article. One example of this is the autograph memorabilia industry. This industry generally involves the selling, in a primary market, and reselling, in secondary markets, of autographed memorabilia items. Such memorabilia items include, but are not limited to, photos, sports items such as baseballs, sticks, various clothing, and other articles. Unfortunately, the monetary value associated with such items creates an incentive for counterfeiting. Such autographed memorabilia items are easy to counterfeit, as the signatures of athletes, celebrities and/or public figures can easily be duplicated and replicated on other memorabilia items. According to the FBI, forgery in the authograph memorabilia industry runs rampant. They also confirm that it is a billion dollar market. Unfortunately, the industry has very little protection, which would prevent against individuals committing forgery by fraudulently duplicating autographs. With no foolproof process in place it is virtually impossible to verify the authenticity of signed memorabilia, while protecting against fraud. Further, the desire for authentication or to authenticate purchasable or transferable objects or items is much broader then the autograph memorabilia industry. Indeed, the desire for authentication may extend to any conceivable industry, including such industries where resale or transfers of items in secondary markets is expected or anticipated.

The desire for authentication is not limited to goods or objects that are commercially or privately transferable. There is a large interest in authentication of identity documents or documents that in general are issued in a controlled manner by a control or regulatory entity and make a representation about a person, entity, or thing in relation to which the document is issued. This interest is heightened due to raised security concerns.

Conventional means of authentication have proven ineffective, or have been too costly for widespread use. One example of an authentication application is disclosed in U.S. Pat. No. 5,128,779 wherein a hologram or diffraction grating is firmly attached to a surface of a document or object that contains visual information desired to be protected from alteration. The reflective discontinuous hologram is formed in a pattern that both permits viewing the protected information through the pattern and the viewing of an authenticating image. Another example is disclosed in U.S. Pat. No. 5,306,899 wherein a bar code symbol is holographically recorded on a substrate base, and when illuminated, a reflected beam is compared with a reference known to be authentic. There are other examples of conventional authentication systems, however, the conventional systems generally do not appear to provide the desired levels of confidence in prevention of fraud or are too complex or costly for widespread implementation.

### SUMMARY OF THE INVENTION

In accordance with a method of the present invention, a method for authenticating an association of an object with an entity is provided. The method comprises the steps of providing entity data, generating a unique identification code, combining the unique identification code with a watermark, and connecting the watermark to the object. The entity data associated with the entity is provided for associating with the product. The unique identification code is generated in an object tracking system for association with the entity data. The watermark with which the unique identification code is combined is a non-removable, substantially invisible watermark. The watermark is connected to the object wherein the watermark indicates the association between the object and the entity and allows tracking, tracing and authentication of the object.

### BRIEF DESCRIPTION OF THE DRAWINGS

The foregoing aspects and other features of the present invention are explained in the following description, taken in connection with the accompanying drawings, wherein:

FIG. 1 is a schematic block diagram of a system incorporating features of the present invention in accordance with a first embodiment; and

FIGS. 2a-2e are a schematic diagram of a system in accordance with another embodiment of the present invention.

### DETAILED DESCRIPTION OF THE PREFERRED EMBODIMENT(s)

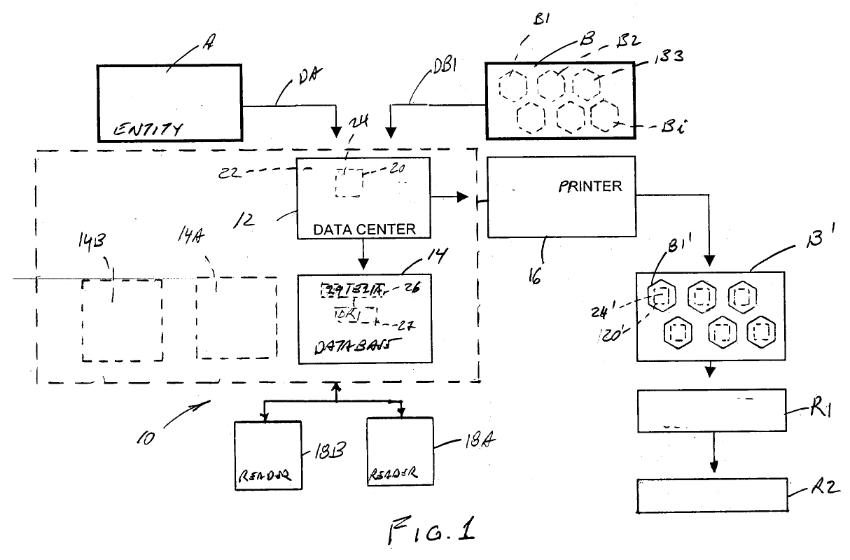

Referring to FIG. 1, a schematic block diagram of a system 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

Still referring to FIG. 1, the system 10 may be used for authenticating an association that exists between an object or set of objects B and an entity A. Further, the system 10 may be used for tracking and tracing the object or set of objects. The authentication and tracking system 10 generally comprises a data center 12, and data bases 14, 14A, 14B. The data bases 14, 14A, 14B and data center 12 are communicably connected to each other to allow information from the data center to be sent and retrieved from the databases. The system 10 also includes printer 16, which is linked to the data center 12. Readers 18A, 18B are connected to the system 10 to communicate with the data center 12. In general, to authenticate the exiting association between object or objects in set B and entity A, data related to entity A and data about the object or objects B1-Bi in set B are input into the data center 12. The data center 12 may generate a unique identification code 24 which may correspond to a given object B1-Bi associated to entity A. The unique code 24 is related to the data of entity A and the data of the given object B1-Bi from the set B and the code 24 along with this entity data and object data may be stored in one of the databases 14. The data center 12 also combines the unique code 24 with a watermark 20. The watermark is printed by printer 16 and connected in some fashion onto the given object B1-Bi. The object with the watermark appended thereto may be transferred or released to a person or other entity, and may be authenticated (or rather may have its association with entity A authenticated) by reading the watermark with a reader 18A, 18B. The code read by the reader when reading the watermark is transmitted to the data center 12. The data center 12 accesses the database to determine if the read code is correct, and hence if the object and the association between the object and entity A is authentic. In addition, further data may be input at the time of authentication in the data center 12 with respect to the state of the object which allow tracking and tracing of the object as will be described in greater detail below.

The objects B1-Bi which may be authenticated with the system 10 could be any conceivable kind of object or item. The objects B1-Bi may be manufactured products or goods, or some other shaped or formed item. For example, the objects may be autographable or autographed collectible items, articles of clothing or clothing accessories, handbags, watches, jewelry, art objects, motor vehicles such as cars, motorcycles, airplanes, boats and parts therefor. The objects may also be weapons, toys, food and drug products, publications, musical instruments, tobacco products, alcoholic products, and pharmaceutical products. In addition, the objects B1-Bi could be memorabilia items, such as trophies, medal, commemorative plaques or documents, antiques, recording media such as DVD's and CD's' digital photographs, as well as packaging of any of the aforementioned or other items and labels or codifications attached thereto. Otherwise, the objects may be documents, such as for example, identification documents. In this case the objects may be a badge, an identity card, a license, motor vehicle related documents and identification plates, passports, digitally downloaded files, or postage stamps. The aforementioned types of items are listed merely for example purposes and not as a limitation, and the objects B1-Bi in FIG. 1, which may be authenticated with the system 10 may be any other conceivable object for which authentication is desired. The objects B1-Bi are shown as being arrayed in a set B for descriptive purpose only and in actuality the objects may not be part of any set. The set B is intended to show that objects B1-Bi may have at least one common attribute or characteristic. This characteristic may be the association between the objects B1-Bi (in the set B) and the entity A. The objects B1-Bi in the set B may not be similar objects and may not be the same kind of objects.

Block A in FIG. 1 is shown and will be described below as being representative of one entity for example purposes only. However, entity A may encompass any number of entities associated with the objects B1-Bi as described. Moreover, entity A may be representative of things and events. For example, entity A could be the manufacturer, distributor, supplier or anyone or anything authorized to place a brand or mark on the objects B1-Bi which would cause an association between the objects and entity. In the case where the object is a historical artifact, entity A may be a historical period or event to which the artifact is related. Alternately, entity A may be a person, such as in the case where the objects are identification documents, an individual or group of individuals which form the subject of the identification documents. Thus, entity A may be any entity with some association to the objects B1-Bi for which authentication is desired.

Still referring to FIG. 1, the data center 12 generally includes a suitable processing system (not shown) for entering, storing and processing data. The data center may be linked through suitable connection means to data input terminals (not shown) through which data about entity A and objects B1-Bi may be input into the data center 12. The input terminals may be located proximally within the same facility as the data center 12, and connected for example by a local area network (LAN) or a wireless proximity network. Alternately, a number of the input terminals may be remotely located, such as for example at a facility used by entity A, communicating with the data center 12 over the Internet or any other suitable communication system such as a cellular communication system. The data center 12 may be a network of centers communicably linked with each other. The data center 12 has suitable code generation software 22 capable of generating a unique identification code 24, and of relating the code 24 to data corresponding to entity A and data corresponding to objects B1-Bi associated with entity A. Each unique identification code 24 may be related to a given object B1 or a given group of objects B1-B1 from the set. The code 24 may be an alphanumeric code with any suitable number of characters. The code is randomly generated and encrypted. The code 24 and corresponding entity A, and object B1 data is stored in a suitable register 26 in the database 14. In the embodiment shown in FIG. 4, the database 14 is shown as corresponding to data associated with entity A. However, the database software may be used to organize the stored data in any suitable manner.

The data entered for the entity A, may be made up of, for example, alphanumeric characters, such as a word or term which may identify the entity A or a characteristic of the entity A. For instance, the data may identify a name of the entity A or a service provided by or a type of entity. The above data description for entity A is merely exemplary, and any other desirable data with regard to the entity may be registered as noted before, to effect the authentication and tracking function of the system 10, data about the objects B1-Bi may be entered into the system. This data may also be entered in alphanumeric characters, or any other suitable characters, and may be an identifier of each object B1-Bi or a number of objects. For example, the data may identify the type of object, a lot number, an item number or serial number of the object. The object data may also be a name of a person which is designated to receive the object, such as in the case of an identification document. The data for entity A may also be a person.

The data center 12 further includes software for generating an electronic embodiment of a watermark 20 which may be communicated from the data center 12 for printing from printer 16. When printed by printer 16, the watermark 20′ (reference designation 20′ corresponds to the printed embodiment of the watermark) is substantially invisible. The software in the data center 12 further allows the identification code 24 to be combined into the watermark 20 so that when printed, watermark 20′ includes the substantially invisible identification code 24′. Suitable watermark generation software for the data center is available from MediaSec Technologies for example.

As noted before, printer 16 receives the watermark printing instructions from the data center 12 and generates the substantially invisible watermark 20′ with the substantially invisible code 24′ therein. The printer 16 (only one printer 16 is shown for example purposes, though the system may include any suitable number of printers) is connected to the data center 12 by any suitable communication lines (not shown) such as a LAN, local or cellular wireless network, or the Internet. The printer 16 may be provided with suitable print heads to allow printing of the watermark 20′ directly onto objects B1′-Bi′. The printing heads of the printer 16 may be capable of printing the substantially invisible watermark 20′ directly on any desired surface texture including polished metal surfaces, wood, and leather surfaces. Further, the printer heads of printer 16 may be capable of printing the substantially invisible watermark 20′ on any desirable surface shape including, for example, concave and convex surfaces. If printing of the watermark directly onto the object is not desired, then the printer 16 may print the substantially invisible watermark 20′ onto labels, tags, packaging or any other media which is attached or connected to the objects. These labels, tags, or other media may be attached to the objects in such a manner as to be substantially irremovable, or may be removed only through the destruction of the label or tag, and the substantially invisible watermark thereon. The substantially invisible watermark 20′ connected to the objects B1′-Bi′ is thus substantially tamperproof. The near invisibility of the watermark 20′ further aids in the tamper resistance of the watermark. In the case where the objects B1′-Bi′ are identity documents which have a digital image affixed thereon, such as for example a digital photograph or logo on a badge, the watermark data 20 and code 24 may be combined with the digital image data so that the watermark 20′ is printed in combination with the digital image on the document. However, copying of the image on the document will not capture the substantially invisible watermark 20′ or code 24′ included therein.

After the watermark 20′ is connected to the objects B1′-Bi′, one or more of the objects may be distributed or transferred by any suitable means to recipients R1. These first tier recipients R1 are the first recipients to receive the marked objects B1′-Bi′. For example, if the objects B1′-Bi′ are manufactured goods and entity A was the manufacturer, the first tier recipient R1 may be a retailer to which the objects B1′-Bi′ are sold wholesale. Otherwise, if the entity A is a retailer, the objects B1′-Bi′ being marked with watermark 20′ at the direction of the retailer, the first tier recipient may be a retail purchaser. In the case the objects B1′-Bi′ are identity documents, and entity A is the regulatory agency or authority under the direction of which the documents are issued, the first tier recipient may be the persons to which the authority is issuing the documents. Otherwise, the first tier recipients R1 may be sub-agencies, subordinate to entity A with the responsibility of issuing the marked documents (i.e. objects B1′-Bi′) to intended holders of the documents. It is noted, that only one first tier recipient R1 is shown in FIG. 1 for example purposes only, though it can be readily realized that there may be any desired number of first tier recipients R1. After receiving the marked objects B1′-Bi′, the first tier recipient R1 may desire to authenticate one or more of the objects B1′-Bi. The first tier receipt R1 may use a reader 18A, 18B of the system 10 to authenticate the object B1-Bi′, or in other words, authenticate the association between the object and entity A.

As noted before, the readers 18A, 18B may be connected by any suitable communication means, such as for example the public telephone network, the Internet, or a wireless communication network, with the data center 12. The readers 18A, 18B (only two readers are shown in FIG. 1 for example purposes, though the system 10 may have any desirable number of readers) are capable of scanning the substantially invisible watermark 20′ on the objects. The readers 18A-18B transmit the electronic data embodying the watermark to the data center 12, and the data center 12 identifies the identification code 24 included into the watermark. The data center 12 accesses the database 14 and compares the identified identification code of the read watermark with the stored identification codes in the registers 26 of the database. If a matching identification code is found in the database, then the data center 12 sends another response to the reader 18A, 18B instructing the reader to display an “invalid” readout on the reader display. The “valid” readout by the reader 18A, 18B indicates that the object B1′-Bi′ is authentic or that the association of the object to entity A is authentic. The “invalid” readout shows that the object is not authentic.

The reader 18A, 18B may further be capable of sending to the data center 12 a reader identification signal which identifies which reader 18A, 18B performed the reading of the object B1′-Bi′. This signal from the reader may for example identify the geographic location of the reader 18A, 18B. The location signal may be recorded by the data center in the database 14. This enables the data center to track and trace the object. The tracking data DR1 from the reader 18A, 18B may be recorded in a suitable register 27 of the database such as a register related to the data register 26 with the original data for entity A and the objects B1′-Bi′. For example, when the object B1′-Bi′ is an identification badge or license, scanning of the badge at a reader to authenticate the badge, serves to authenticate the badge and also locate its use which allows the tracking and tracing of the badge with the system. As the badge is used further, the data center updates the tracking information in the data base to track the badge. When tracking information is sought about the badge, such as from a duly authorized entity, the data center accesses the tracking data for the given object from the data base 14. The data center 12 of the system 10 is capable of displaying the tracking data at appropriate terminals including for example the readers 18A, 18B as well as other remote access terminals (not shown). The data center 12 is further capable of sending the authentication response regarding the read identification code to the remote access terminal in conjunction with the response to the readers 18A, 18B, or in place of the response to the readers. For example, when a badge holder (i.e. recipient R1) uses the badge and has it read by a reader 18A, 18B, the authentication response may be sent back to the reader validating/invalidating the badge, and to a remote access terminal at a security office or other control authority. A similar process may be used in the case where the object is a manufactured product or good, where the response from, the system 10 is sent to the holder scanning the object and to a remote terminal observed by the manufacturer, or the recipient entity R1, or any other interested and authorized party. In this manner pharmaceuticals may be scanned by the druggist for validation against the script or by the manufacturer for proper packaging.

The system 10 allows the first tier recipient R1 to register the object B1′-Bi′ as being in its possession in order to aid further tracking and tracing of the object such as in the event of re-transfer of the object to a second tier recipient 2 (see FIG. 1). The readers 18A, 18B may be linked with or provided with input terminals allowing the recipient R1 to enter registration data about the recipient in association with authentication of the object B1′-Bi′. An invalid authentication response will disallow subsequent registration of the purported recipient. The recipient data may be in any form and may include identification data such as name, social security number in the case the recipient is a person, or other suitable identifying information to accurately identify the recipient. The registration data may be transmitted to the data center 12 which stores it in a suitable database register 27 associated with the object B1′-Bi. The registrant may be allowed to select or be otherwise provided with a registration identification code (e.g. a user name, password or any other suitable identification code) which relates the object B1′-Bi′registration to the registrant, and allows the registrant to maintain and update any information in the tracking system. For instance, the registrant may indicate whether the object B1′-Bi′ is lost or stolen. The registrant may also indicate whether the object was further transferred to a second tier recipient R2. An indication by the registrant that the object has been properly transferred will allow a subsequent recipient R2 to register with the system. Otherwise, subsequent registration may be refused by the system 10. The subsequent registrant may register in a similar manner to that described before, also in conjunction with authentication of the object B1′-Bi′. The second tier recipient R2 thus may authenticate the object received from the prior tier recipient, and may further the tracking function of the system. However, registration by any recipient of the objects is not required for the system to operate in accordance with this invention.

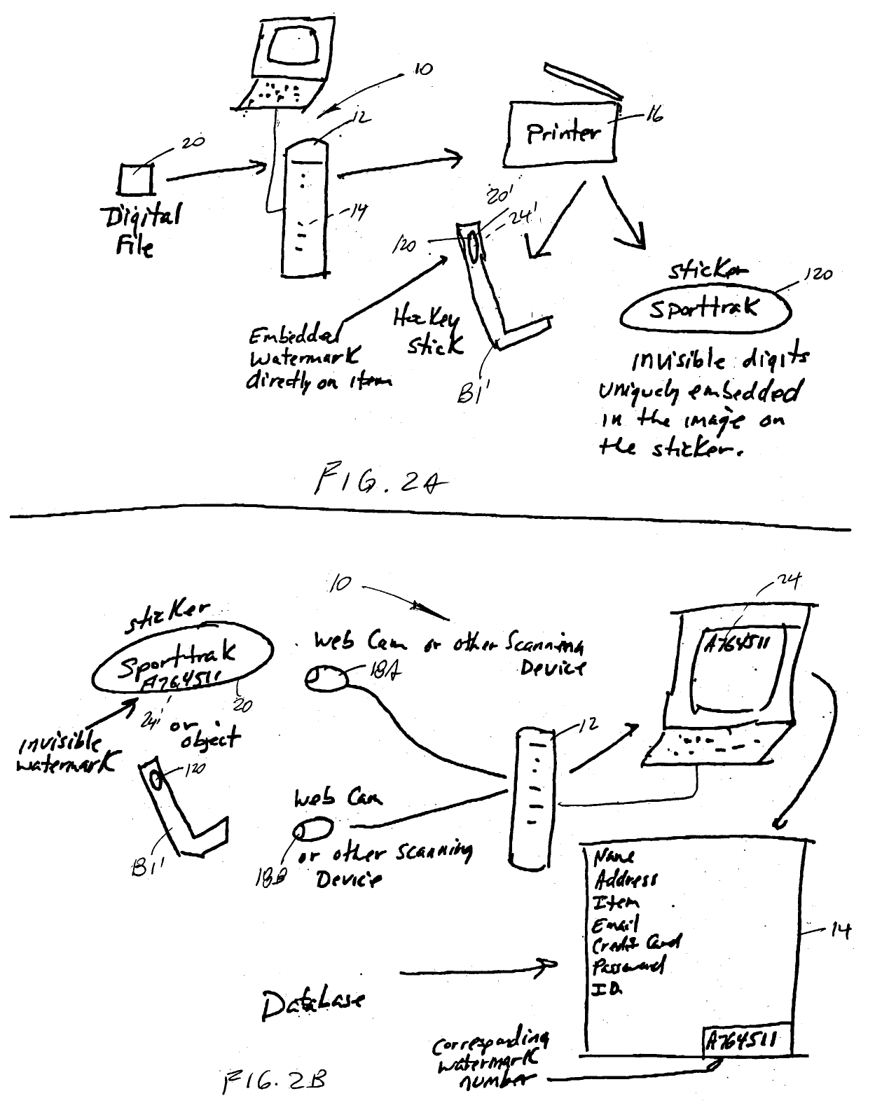

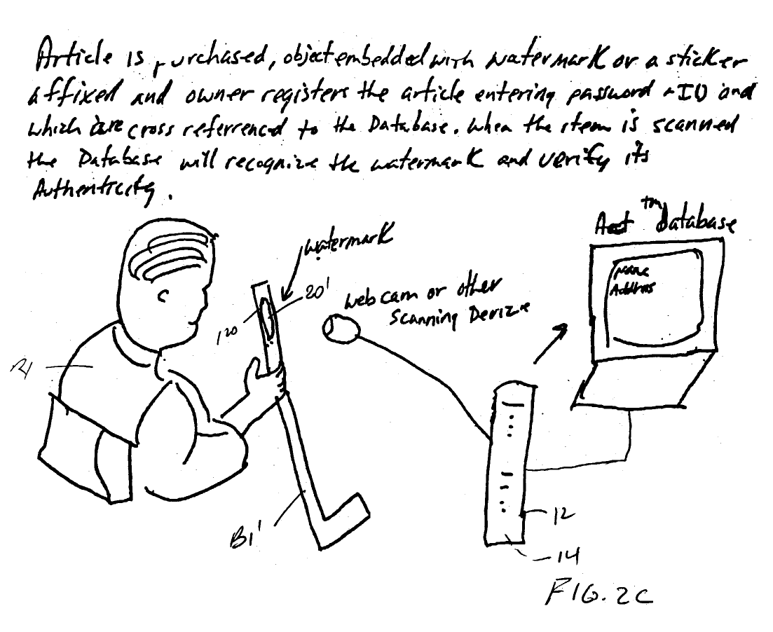

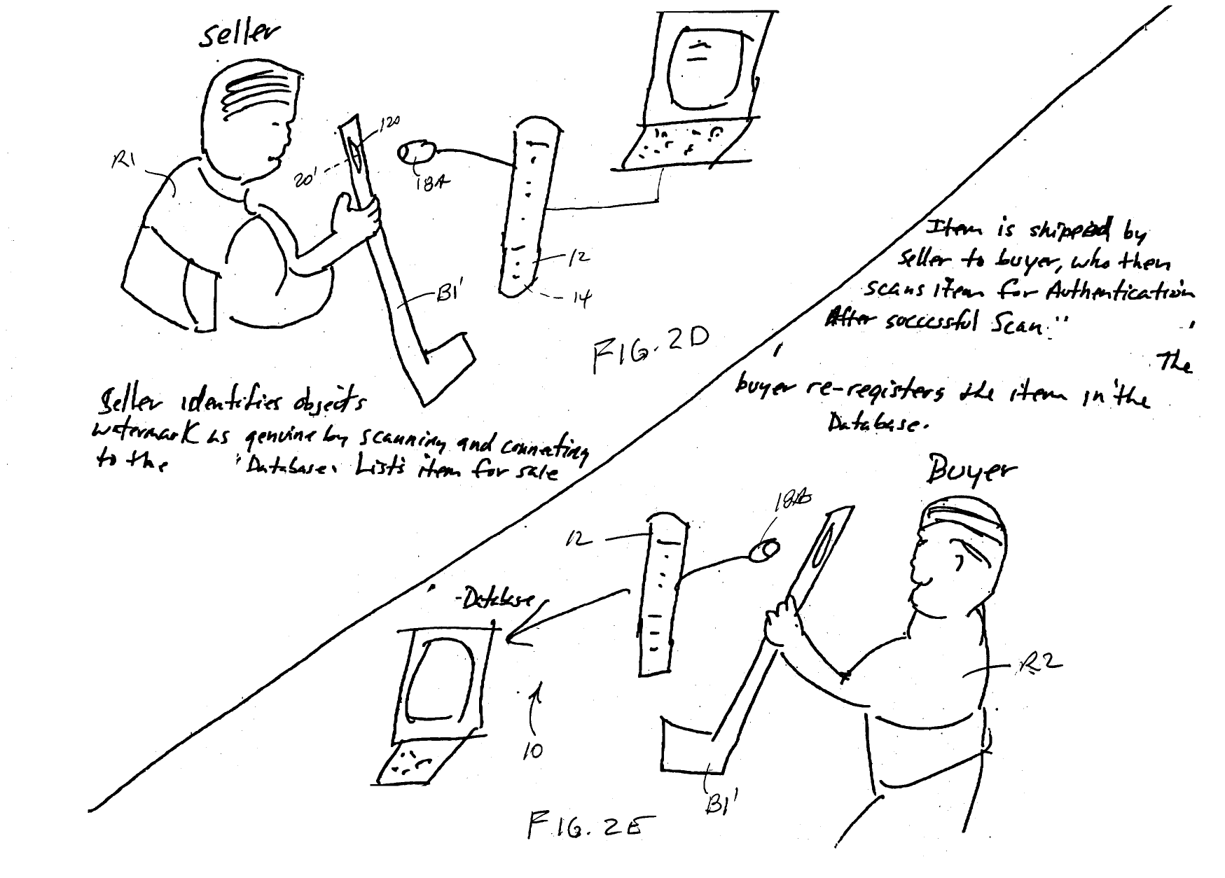

The system 10 may be used advantageously for example in the autographed memorabilia industry in accordance with the process described in U.S. patent application Ser. No. 10/117,265, filing date Apr. 5, 2002 which is incorporated by reference herein in its entirety. FIGS. 2A-2E depict another embodiment illustrating another example of how system 10 may be used in accordance with the present invention. In FIG. 2A, the digital file for the watermark 20, including the identification code 24 is generated by the data center 12. The digital file is transmitted to printer 16 which in this case prints the substantially invisible watermark 20′ on a sticker 120. The sticker 120 may be affixed to the object B1′, in this embodiment schematically depicted as a hockey stick. In this case, the article data is recorded in the system 10 after or substantially at the same time with printing of the watermark and its affixation to the object. In alternate embodiments, recordation of the entity and object data may be recorded into the system at any suitable time. FIG. 2B schematically depicts the recordation of the entity and object data into the system. In this embodiment the watermark 20′ on the object B1′ is scanned with reader 18A, 18B to identify the code 24′ for the watermark 20′. The article data is input into the data center 12 and related to the code 24. The code and article data are stored in the database 14 registers. After recordation in the system the object B1′ may be sold to a first tier recipient. The recipient R1 may use system 10 as shown in FIG. 2C to register with the system. The recipient R1 scans the watermark 20′ on the object B1′ to verify its authenticity and enters password and personal detail information. This is cross-referenced by the data center 12 with the code 24 and stored in the database 14. FIG. 2D shows the first tier recipient R1, in this case acting as the seller, accessing the system 10 as part of the sale of the object B1′ to a second tier recipient. The seller scans the watermark 20′ on object B1′, which initiates a validation response from the system. The system 10 allows the validation response to be directed, along with sale information about the object, to be posted on a desired Internet web site for example. This informs any interested party accessing the site that the object posted for sale on the site is authentic. A buyer, or second tier recipient R2 may agree to the terms of the sale and purchase the object B1′. The object B′1 may be shipped to the buyer R2. As shown in FIG. 2E, upon receipt of the object, the buyer R2 may use the system 10 to authenticate the object B1′ as described before. When the valid response is received, the buyer may re-register the object in the data base in a similar manner to the first tier recipient R1 shown in FIG. 2B and described before. This process may be repeated any desired number. In this manner, the system 10 authenticates the object and tracks and traces the object preventing any possible fraud.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for authenticating an association of an object with an entity, the method comprising the steps of:
providing entity data associated with the entity for associating with the object;
generating a unique identification code for association with the entity data in an object tracking system;
combining the unique identification code with a non-removable, substantially invisible watermark; and
connecting the watermark to the object, wherein the watermark indicates the association between the object and the entity and allows tracking, tracing and authentication of the object.

2. The method of claim 1, wherein the object is an autographable collectible, an autographed collectible, an article of clothing, a shoe, a handbag, a watch, an art object, a car, a motorcycle, a computer, a pair of sunglasses, an airplane part, a music compact disk, a weapon, a toy, a food product, a drink product, a book, a musical instrument, a tournament trophy, a medal, an antique, a greeting card, a tobacco product, an alcoholic product, a pharmaceutical product, a film article, a digital photograph, a DVD, packaging, a label or a bar code.

3. The method of claim 1, wherein the entity is a company, a person, a producer of the object, a manufacturer of the object, or a distributor of the object.

4. The method of claim 1, wherein the entity data is an identifier of the entity.

5. The method of claim 4, wherein the identifier is at least one word.

6. The method of claim 1, wherein the entity data is an identifier of a service provided by the entity.

7. The method of claim 1, wherein the entity data is an identifier of a person.

8. The method of claim 1, comprising:
reading the watermark connected to the product to acquire the unique identification code;
accessing the product tracking system with the read identification code;
if the read identification code does not match any identification code in the product tracking system, displaying an authentication response of invalid; and
if the read identification code matches one of the unique identification codes in the product tracking system, displaying at least some of the entity data associated with the unique identification code as the authentication response.

9. A method for authenticating an association of a document with an entity, the method comprising the steps of:
providing entity data associated with the entity for associating with the document;
generating a unique identification code for association with the entity data in a document tracking system;
combining the unique identification code with a non-removable, substantially invisible watermark; and
connecting the watermark to the identification document, wherein the watermark indicates an association between the document and the entity.

10. The method of claim 9, wherein the document is a badge, an identity card, a license, corporate identification, motor vehicle related documents and identification plates, a passport, a digitally downloaded file, or a postage stamp.

11. The method of claim 9, wherein the entity is a security organization, a company, a government agency, person, or an issuer of the document.

12. The method of claim 9, wherein the entity data is an identifier of the entity.

13. The method of claim 12, wherein the identifier is at least one word.

14. The method of claim 9, wherein the entity data is an identifier of a service provided by the entity.

15. The method of claim 9, wherein the entity data is an identifier of a person.

16. The method of claim 9, comprising:
reading the watermark connected to the document to acquire the unique identification code;
accessing the document tracking system with the read identification code;
if the read identification code does not match any identification code in the identification code tracking system, displaying an authentication response of invalid; and
if the read identification code matches one of the unique identification codes in the identification code tracking system, displaying at least some of the entity data associated with the unique identification code as the authentication response.
